(19) United States
(12) Patent Application Publication
(10) Pub. No.: US 2014/0060244 A1
(43) Pub. Date: Mar. 6, 2014

(54) RAPID LINK PLATE FOR A CYCLIST'S SHOE ON AN AUTOMATIC CYCLE PEDAL

(71) Applicant: LOOK CYCLE INTERNATIONAL, NEVERS (FR)

(72) Inventor: Victor EGEA, NEVERS (FR)

(73) Assignee: LOOK CYCLE INTERNATIONAL, NEVERS (FR)

(21) Appl. No.: 14/012,105

(22) Filed: Aug. 28, 2013

(30) Foreign Application Priority Data
Aug. 30, 2012 (FR) 12 58125

(51) Int. Cl. B62M 3/08

(52) U.S. Cl. CPC B62M 3/086
USPC 74/594.6

(57) ABSTRACT

The link plate includes fastening holes (14) under the sole of a cyclist's shoe, a front attachment member (5) suitable for cooperating with a front attachment member of an automatic cycle pedal, and a rear attachment member suitable for cooperating with a rear attachment member of the pedal to grip the plate between the front and rear attachment members of the pedal which bear against a front gripping surface (9) and a rear gripping surface (15, 15′) on the front (10), respectively rear (16), rim of the plate (1). At least one of the front and rear gripping surfaces is divided into a plurality of parts by a notch (21, 21′) extending through the entire thickness of the link plate, forming therein an opening for evacuating mud penetrating into an interstice formed between the sole of the shoe and the front (5) and rear (11) attachment members of the plate.

### BACKGROUND OF THE INVENTION

The present invention relates to a rapid link plate for a cyclist's shoe on an automatic cycle pedal.

### DESCRIPTION OF THE PRIOR ART

The rapid link plate is fastened under the sole of the cyclist's shoe and, to this end, comprises fastening holes to be fastened by screws.

Each link plate comprises a front attachment members in the form of a front protrusion that has to be inserted under a front attachment member of the automatic pedal, and a rear attachment member in the form of a rear protrusion that has to be stressed against a movable rear attachment member of the automatic pedal. Generally, the latter is mounted to tilt and is prestressed by an elastic means which usually consists of at least one spring. The rear protrusion of the link plate thus tilts the rear attachment member of the pedal backward to be housed thereunder.

The link plate has a front gripping surface and a rear gripping surface provided on the front, respectively rear, rim of the plate and which are gripped between the front and rear attachment members of the pedal.

The automatic pedals are fitted on cycles used both on the road and on paths or in woodland, on muddy or snowy terrain. The automatic pedals are designed to be adapted to the environment of use. Thus, there are two main categories of automatic pedals, namely automatic road pedals and automatic all-terrain pedals (VTT), suitable for use on cycles of a corresponding design.

The automatic road pedals generally cooperate with large rapid link plates made of plastic material which offer a bearing surface against the pedal that is as large as possible. These link plates are fastened onto the soles of road shoes with a flat and relatively rigid surface.

Things are very different with the automatic all-terrain pedals which are associated with small metal link plates fastened onto the soles of shoes for all-terrain use which are provided with crampons, usually positioned on either side of the link plate and also in front thereof. In this way, the link plate is in a way embedded in the sole. This device thus allows for walking and the link plates wear out as little as possible on abrasive surfaces such as rocks.

The link plates according to the invention relate more particularly to the plates intended for an all-terrain use.

When using an all-terrain cycle provided with the corresponding equipment with regard to the shoes and link plates, it is common practice to place a foot on the ground during a loss of balance. When the ground is muddy or snowy, earth or snow then penetrates into the orifices of the link plates and into the mechanisms of the pedals.

This is why the all-terrain pedals are designed in such a way as to be able to evacuate the mud or snow optimally. On these all-terrain pedals, the link plates are attached to the pedals using attachment members in the form of arches or folded plates which provide the pedals with a very open structure, which allows for the evacuation of the mud which then passes through the many openings on either side of the pedal axis. The arch shape is to be preferred for the openwork structure that it provides, allowing the mud or snow to pass through easily.

Thus, all the mud evacuation means are located on the pedals, whereas the link plates of today do not contribute to mitigating the effects of this problem associated with the build-up of mud or snow.

More specifically, the fact that external matter, hereinafter called “mud”, that can penetrate into the interstice formed between the sole of the shoe and the front and rear attachment members of the plate is neglected. However, a build-up of mud in these places is likely to hamper the cyclist when he has to place his feet back on the pedal.

FIGS. 1 to 4 are intended to illustrate the problem of build-up of mud between the front and rear attachment members of the link plate and the sole of the cyclist's shoe. FIGS. 1 and 2 show a link plate 1 fastened by screws 2 under the sole 3 of a cyclist's shoe (not represented).

FIGS. 1 and 2 illustrate how the interstice 4 between a front attachment member 5 of the link plate 1 and the sole 3 is filled by mud 6. FIGS. 2 and 3 illustrate what can occur when attaching the link plate 1 to an automatic pedal 7. To attach the link plate 1 to the pedal 7, the front attachment member 5 of the plate is first of all offered up to the front attachment member 8, here in the form of an arch, of the pedal 7, to be inserted there under so that a gripping surface 9 provided on the front rim 10 of the link plate 1 abuts against the front attachment member 8 of the pedal.

However, during this initial attachment phase, the front attachment member 8 of the pedal 7 exerts a reaction force (illustrated by an arrow in FIGS. 3 and 4) which packs down the mud which will remain between the gripping surface 9 of the link plate and the front attachment member 8 of the pedal.

The mud will remain captive in the interstice 4 between the sole 3 and the front attachment member 5 of the link plate 1 and placing the foot on the pedal will consequently become increasingly difficult as the mud is packed down in this place.

A similar phenomenon will occur on the rear attachment member 11 of the link plate 1 and on the rear attachment member 12 of the automatic pedal 7 (see FIG. 10).

Finally, FIG. 4 schematically illustrates the front part of a known link plate 1 in which the front rim 10 of the plate has a central point 13 against which the front attachment member 8 of the pedal exerts its force. This point 13 also serves to drive out the mud 6 on either side by its angle-forming edges. However, this point has practically no effect for the evacuation of the mud since it can displace only a small portion of the mud to the sides.

The aim of the invention is to propose a link plate that makes it possible to easily evacuate the mud which otherwise would be packed down into the interstice between the sole and the front and rear attachment members of the plate.

### SUMMARY OF THE INVENTION

The object of the invention is a rapid link plate for a cyclist's shoe on an automatic cycle pedal, comprising holes for fastening the plate under the sole of a cyclist's shoe, a front attachment member suitable for cooperating with a front attachment member of an automatic cycle pedal, and a rear attachment member suitable for cooperating with a rear attachment member of the pedal so as to grip the plate between said front and rear attachment members of the pedal which bear against a front gripping surface and a rear gripping surface provided on the front, respectively rear, rim of the plate, wherein at least one of said front and rear gripping surfaces is divided into a plurality of parts by at least one notch extending through the entire thickness of the link plate, from a top face to a bottom face thereof, forming therein an opening for evacuating to said bottom face external matter likely to penetrate into an interstice formed between the sole of the shoe and the front and rear is attachment members of the plate. According to other features of the invention:

a notch forming a single evacuation opening placed at the center of the front rim divides the front attachment member of the plate into two parts;

the plate has, in the place of the front attachment member, a part with contour directed inward so that the face of each part of the front attachment member that has to face toward the sole of the shoe forms therewith an evacuation channel communicating with said evacuation opening-forming notch;

two evacuation opening-forming notches positioned on either side of the rear attachment member of the plate divide the rear gripping surface into three parts;

the plate has, on either side of a central gripping surface, in the place of the rear attachment member, a part with contour in extension of the contour of the respective notch and linked to the central gripping surface so that the face of a part of the rear attachment member that has to face toward the sole of the shoe and positioned on either side of said central gripping surface forms, with the sole of the shoe, an evacuation channel communicating with a respective evacuation opening-forming notch;

a distribution depression is formed around each evacuation opening-forming notch on the face of the plate that has to face toward the pedal;

said depressions communicate with one another;

the bottom of each evacuation opening-forming notch has a rounded shape; and

the front attachment member is suitable for cooperating with an arch shaped front attachment member of an automatic pedal cycle, and the rear attachment member is suitable for cooperating with an arch shaped rear attachment member.

### BRIEF DESCRIPTION OF THE DRAWINGS

Other features and advantages of the invention will emerge from the following description of a nonlimiting embodiment of the invention, with reference to the appended figures in which:

FIGS. 1 to 4 illustrate the drawbacks of the known link plates described in the introduction;

FIG. 5 is a perspective view from above of a link plate according to the invention;

FIG. 6 is a plan view of the plate of FIG. 5,

FIG. 7 is a perspective view from below of a link plate according to the invention;

FIGS. 8 and 9 are partial views from below, respectively in perspective of a sole of a cyclist's shoe bearing a link plate according to the invention;

FIG. 10 is a schematic side view, in partial cross section, illustrating the initial phase of the attachment of the link plate according to in the invention fastened under a sole;

FIG. 11 is a partial perspective view showing the link plate according to the invention in the attachment phase, the sole having been removed for more clarity; and

FIG. 12 is a schematic view illustrating the operation of the link plate according to the invention for evacuating the mud during its attachment to the automatic pedal.

In the figures, the elements that are identical or equivalent will bear the same reference signs.

### DESCRIPTION OF THE PREFERRED EMBODIMENT

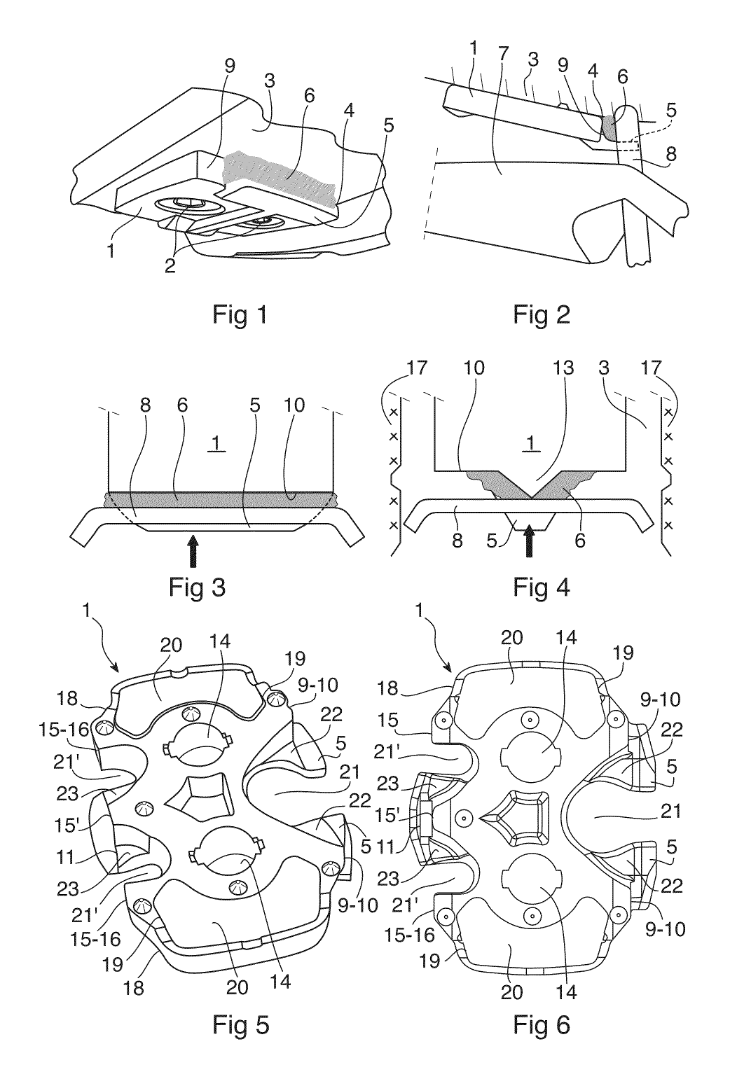

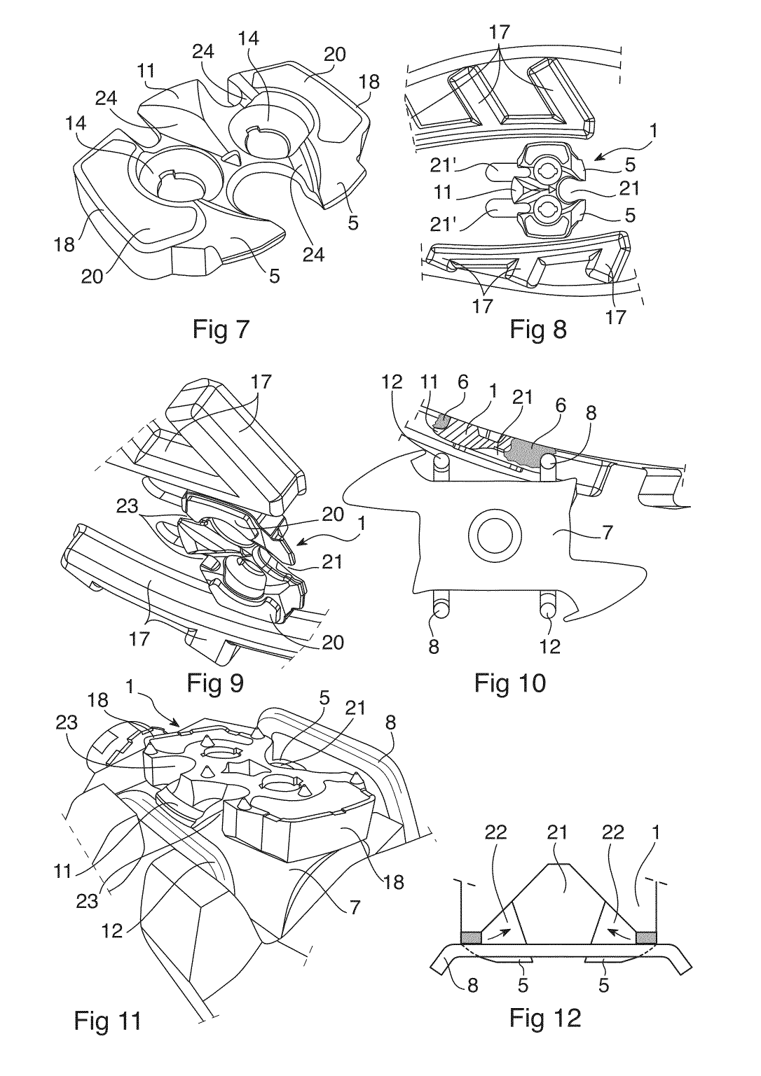

The link plate 1 according to the invention illustrated in FIGS. 1 to 12 conventionally comprises through holes 14 for fastening the link plate under the sole 3 of the cyclist's shoe (not represented), a front attachment member 5 suitable for cooperating with a front attachment member 8 of an automatic cycle pedal 7, and a rear attachment member 11 suitable for cooperating with a rear attachment member 12 of the pedal. In its position engaged on the pedal, the link plate 1 is gripped between the front and rear attachment members 8, 12 of the pedal which bear against a front gripping surface 9 and a rear gripping surface 15 provided on the front 10, respectively rear 15, rim of the plate 1.

The sole 3 is also provided with rows of crampons 17 positioned on either side of the link plate 1 so that the latter is practically integrated in the sole.

Furthermore, the link plate according to the invention illustrated in the figures comprises, on two opposite side wings 18, a respective recess 19 for receiving an elastic block 20 which protrudes slightly downward to serve as a bearing surface for walking, complementing the crampons 17, when the cyclist has taken the shoe off the pedal.

According to the invention, at least one of the front and rear gripping surfaces 10, 15 of the link plate 1 is divided into a plurality of parts by at least one notch 21 forming an opening for evacuating external matter 6 likely to penetrate into an interstice 4 formed between the sole 3 of the shoe and the front and rear attachment members 5, 11 of the plate. The evacuation opening-forming notch 21 is a through notch extending through the entire thickness of the link plate from a top face to a bottom face thereof, allowing the mud to pass through to the bottom face for its evacuation to the pedal.

This dividing up of the front and/or rear gripping surface 10, 15 has the direct consequence of causing this surface to be reduced, which will firstly result in a reduction of the surface on the rim 10 and/or 15 against which the mud 6 can be stressed by the corresponding attachment member of the pedal, and secondly in an increase in the pressure that it exerts on the accumulated mud (see FIG. 12). The mud 6 will thus be forced toward the evacuation opening-forming notch 21.

In the example illustrated in the figures, a single evacuation opening-forming notch 21 is placed at the center of the front rim 10 of the plate so as to divide the front attachment member 5 into two parts.

The link plate 1 has, in the place of the front attachment member 5, a part with contour directed inward so that the face of each part of the front attachment member that has to face toward the sole of the shoe forms therewith an evacuation channel 22 communicating with the central evacuation opening-forming notch 21.

Also in the example illustrated, two evacuation opening-forming notches 21′ which are positioned on either side of the rear attachment member 11 of the plate divide the rear gripping surface into three parts.

The link plate 1 here has, on either side of a central gripping surface 15′, in the place of the rear attachment member 11, a part with contour in extension of the contour of the respective notch 21′ which is linked to the central gripping surface 15′ so that the face of a part of the rear attachment member 11 that has to face toward the sole 3 of the shoe and positioned on either side of said central gripping surface forms, with the sole of the shoe, an evacuation channel 23 communicating with a respective notch 21′.

The configuration described with a front central notch 21 and two rear side notches 21′ seems to be an optimum solution for the evacuation of the mud which would otherwise be captive and compacted in the interstice 4.

It is obvious that all the combinations can be envisaged without in any way departing from the framework of the invention.

Moreover, the link plate 1 is advantageously, on its face that has to face toward the pedal, provided, around each evacuation opening-forming notch 21, 21′, with a distribution depression 24 for distributing the mud which is expelled through the corresponding notch.

Advantageously, these distribution depressions 24 communicate with one another.

Finally, the bottom of each evacuation opening-forming notch 21, 21′ is rounded.

Obviously, the invention is not limited to the example illustrated and described, but can be applied to any link plate for an automatic pedal.

1. A rapid link plate for a cyclist's shoe on an automatic cycle pedal (7), comprising holes (14) for fastening the plate (1) under the sole (3) of a cyclist's shoe, a front attachment member (5) suitable for cooperating with a front attachment member (8) of an automatic cycle pedal (7), and a rear attachment member (11) suitable for cooperating with a rear attachment member (12) of the pedal so as to grip the plate (1) between said front and rear attachment members (8, 12) of the pedal which bear against a front gripping surface (9) and a rear gripping surface (15, 15′) provided on the front (10), respectively rear (16), rim of the plate (1), wherein at least one of said front (9) and rear (15) gripping surfaces is divided into a plurality of parts by at least one notch (21, 21′) extending through the entire thickness of the link plate, from a top face to a bottom face thereof, forming therein an opening for evacuating to said bottom face external matter likely to penetrate into an interstice (4) formed between the sole (3) of the shoe and the front (5) and rear (11) attachment members of the plate.

2. The rapid link plate as claimed in claim 1, wherein a notch (21) forming a single evacuation opening placed at the center of the front rim (10) divides the front attachment member (5) of the plate into two parts.

3. The rapid link plate as claimed in claim 2, wherein the plate (1) has, in the place of the front attachment member (8), a part with contour directed inward so that the face of each part of the front attachment member (8) that has to face toward the sole of the shoe forms therewith an evacuation channel (22) communicating with said evacuation opening-forming notch (21).

4. The rapid link plate as claimed in claim 1, wherein two evacuation opening-forming notches (21′) positioned on either side of the rear attachment member (11) of the plate divide the rear gripping surface (15, 15′) into three parts.

5. The rapid link plate as claimed in claim 4, wherein the plate (1) has, on either side of a central gripping surface (15′) in the place of the rear attachment member (11), a part with contour in extension of the contour of the respective notch (21′) and linked to the central gripping surface (15′) so that the face of a part of the rear attachment member that has to face toward the sole of the shoe and positioned on either side of said central gripping surface forms, with the sole of the shoe, an evacuation channel (23) communicating with a respective evacuation opening-forming notch (21′).

6. The rapid link plate as claimed in claim 1, wherein a distribution depression (24) is formed around each evacuation opening-forming notch (21, 21′) on the face of the plate that has to face toward the pedal (7).

7. The rapid link plate as claimed in claim 6, wherein said distribution depressions (24) communicate with one another.

8. The rapid link plate as claimed in claim 1, wherein the bottom of each evacuation opening-forming notch (21, 21′) has a rounded shape.

9. The rapid link plate as claimed in claim 1, wherein the front attachment member (5) is suitable for cooperating with an arch shaped front attachment member (8) of an automatic cycle pedal (7), and the rear attachment member (11) is suitable for cooperating with an arch shaped rear attachment member (12).

10. The rapid link plate as claimed in claim 2, wherein a distribution depression (24) is formed around each evacuation opening-forming notch (21, 21′) on the face of the plate that has to face toward the pedal (7).

11. The rapid link plate as claimed in claim 3, wherein a distribution depression (24) is formed around each evacuation opening-forming notch (21, 21′) on the face of the plate that has to face toward the pedal (7).

12. The rapid link plate as claimed in claim 4, wherein a distribution depression (24) is formed around each evacuation opening-forming notch (21, 21′) on the face of the plate that has to face toward the pedal (7).

13. The rapid link plate as claimed in claim 5, wherein a distribution depression (24) is formed around each evacuation opening-forming notch (21, 21′) on the face of the plate that has to face toward the pedal (7).

14. The rapid link plate as claimed in claim 2, wherein the bottom of each evacuation opening-forming notch (21, 21′) has a rounded shape.

15. The rapid link plate as claimed in claim 2, wherein the front attachment member (5) is suitable for cooperating with an arch shaped front attachment member (8) of an automatic cycle pedal (7), and the rear attachment member (11) is suitable for cooperating with an arch shaped rear attachment member (12).
